(19) United States
(12) Patent Application Publication
(10) Pub. No.: US 2015/0138433 A1
(43) Pub. Date: May 21, 2015

(54) Illumination Control System and Illumination Control Method

(71) Applicant: Gunitech Corp., Hsinchu County (TW)

(72) Inventors: Chi-Jung Wang, Hsinch County (TW); Huan-Ruei Shiu, Hsinchu County (TW); Po-Kuei Chou, Hsinchu County (TW); Yueh-Chang Wu, Hsinchu County (TW); Ming-Chuan Tsai, Hsinchu County (TW); Ya-Chi Tseng, Hsinchu County (TW); Yu-Feng Chen, Hsinchu County (TW); Chien-Ju Hung, Hsinchu County (TW)

(73) Assignee: Gunitech Corp., Hsinchu County (TW)

(21) Appl. No.: 14/230,048

(22) Filed: Mar. 31, 2014

(30) Foreign Application Priority Data
Nov. 20, 2013 (TW) 102142156

(51) Int. Cl. H04N 5/235

(52) U.S. Cl. CPC H04N 5/2354
USPC 348/370

(57) ABSTRACT

An illumination control method and an illumination control system for controlling at least one illuminating device are disclosed. The illumination control method includes following steps: capturing an image through an image capturing device; analyzing a characteristic of the image; and generating a first control signal.

### BACKGROUND OF THE INVENTION

1. Field of the Invention

The present invention relates to an illumination control system and an illumination control method, and particularly to an illumination control system and an illumination control method for changing the illumination mode of an illuminating device through analyzing a characteristic of an image.

2. Description of the Related Art

With the continuous development of illuminating devices, whether traditional illuminating devices, such as fluorescent tubes, or the light-emitting diodes widely used in recent years, devices have been developed to allow users to switch the devices On/Off in a user-configurable time. However, the timing feature of the illuminating device is unable to make appropriate changes in the illumination mode according to the ambient brightness. Some undesirable situations, such as when the lights are automatically turned on because it is time for them to be to turned even though the ambient light is very bright, or the lights are not automatically turned on because it is not the time for them to be turned on even thought the ambient light is very dim, may occur. As a result, illuminating devices that are too bright may waste energy, or insufficiently bright illuminating devices may cause inconvenience to the user. Therefore, it is necessary to make improvements.

### SUMMARY OF THE INVENTION

It is a major objective of the present invention to provide an illumination control system for changing the illumination mode of an illuminating device through analyzing a characteristic of an image.

It is another major objective of the present invention to provide an illumination control method for changing the illumination mode of an illuminating device through analyzing a characteristic of an image.

To achieve the objectives described above, the illumination control system of the present invention includes an electronic device. The electronic device includes an image capture device, an image analysis module, a processing module, and a wireless transmission module. The image capture device is used for capturing an image. The image analysis module is used for analyzing an image characteristic of the image. The processing module is electrically connected to the image capture device and the image analysis module. The processing module generates a first control signal according to the image characteristic. The wireless transmission module is electrically connected to the processing module and used for transmitting the first control signal. The first control signal is used for the purpose of controlling said at least one illuminating device.

The present invention further provides an illumination control method applied to an electronic device such that the illumination mode of the at least one illuminating device is controlled by the electronic device. The electronic device includes an image capture device, and the illumination control method includes the following steps: capturing an image through the image capture device; analyzing an image characteristic of the image; and generating a first control signal according to the image characteristic of the image.

Through the design of analyzing an image characteristic of an image, the current state of the environment can be observed so that the illumination mode of the illuminating device can be adjusted accordingly, which increases the usefulness of the illuminating device.

### BRIEF DESCRIPTION OF THE DRAWINGS

FIG. 1A is a hardware architecture diagram of an illumination control system according to a first embodiment of the present invention;

FIG. 1B is a view showing a first control parameter database according to a first embodiment of the present invention;

FIG. 2 is a flowchart showing the steps of an illumination control method according to the first embodiment of the present invention;

FIG. 3 is a view showing the change of illumination mode in an illuminating device through the illumination control system according to an image characteristic of an image;

FIG. 4 is another view showing the change of illumination mode in an illuminating device through the illumination control system according to an image characteristic of an image;

FIG. 5 is a hardware architecture diagram of an illumination control system according to a second embodiment of the present invention;

FIG. 6A is a view showing a second control parameter database according to a second embodiment of the present invention; and

FIG. 6B is a flowchart showing the steps of the illumination control method according to the second embodiment of the present invention.

### DETAILED DESCRIPTION OF THE PREFERRED EMBODIMENT

To facilitate understanding and to clarify the object, characteristics, and advantages of the present disclosure, the following three specific embodiments and figures illustrating the present disclosure are presented as a detailed description.

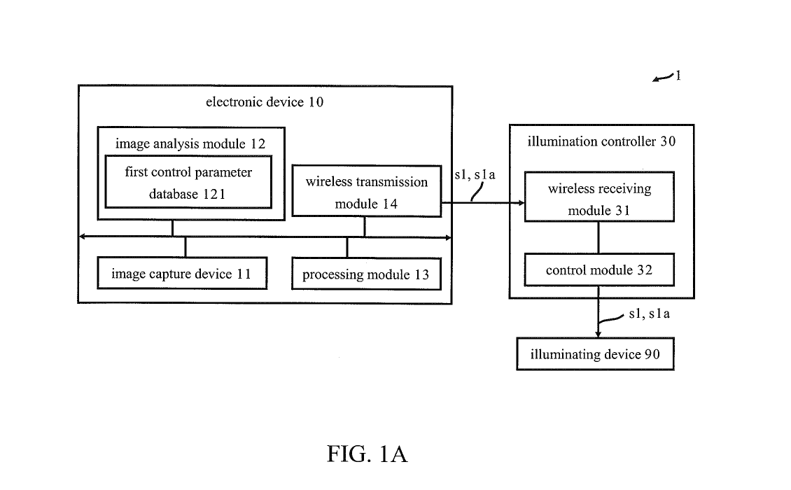

Please first refer to FIGS. 1A and 1B, wherein FIG. 1A is a hardware architecture diagram of an illumination control system according to a first embodiment of the present invention; FIG. 1B is a view showing a first control parameter database according to a first embodiment of the present invention. The illumination control system 1 of the present invention controls at least one or a plurality of illuminating devices 90, wherein the illuminating device 90 in the present embodiment is a light-emitting diode, but the present invention is not limited to this. The illuminating device 90 can be another device with a lighting feature.

In the present embodiment, the illumination control system 1 includes an electronic device 10 and an illumination controller 30. The illumination controller 30 is respectively connected to the electronic device 10 and the illuminating device 90, such that the illumination mode of the illuminating device 90 is controlled by the electronic device 10 through the illumination controller 30, for example, to change the brightness, color temperature, color, On/Off, Flashing mode, or Color-changing mode of the illuminating device 90. Please note that the electronic device 10 can be a smart phone or a tablet computer, but the present invention is not limited to this and can be applied to another electronic device with an image capture function.

As shown in FIG. 1A, in a first embodiment of the present invention, the electronic device 10 includes an image capture module 11, an image analysis module 12, a processing module 13, and a wireless transmission module 14. The processing module 13 is electrically connected to the abovementioned modules. The image capture device 11 is used for capturing an image 100, which can be a still image or a moving image. In the present embodiment, the image capture device 11 can be one or multiple lenses which can be selectively mounted onto the electronic device 10. The image capture device 11 can be situated toward any direction where the electronic device 10 is situated at to obtain the image 100 of the surrounding environment corresponding to the position of the electronic device 10.

As shown in FIG. 1A, the image analysis module 12 analyzes the image 100 captured by the image capture module 11 to identify the image characteristic 110 of the image 100. In the present invention, the image characteristic 110 includes the overall brightness, grayscale and color difference, or color information of the image 100. It is noted that the technique of analyzing the image characteristic 110 of the image 100 is known by those skilled in the art, and thus the details of the analysis are omitted herein.

As shown in FIG. 1B, the image analysis module 12 in the present embodiment includes a first control parameter database 121, by which the processing module 13 can determine the control parameter corresponding to the image characteristic 110 after the image analysis module 12 completes the image analysis in order to generate the first control signal s1 corresponding to the image characteristic 110 for controlling the illuminating device 90.

It is noted that the first control signal s1 includes the change of brightness, color temperature, color, On/Off, Flashing mode, or Color-changing mode of the illuminating device 90. The various image characteristics 110 correspond to different first control signals s1. Also, the embodiments of the first control signal s1 can be pre-determined by the developer of the illumination control system 1 or set by users according to their needs, and are not limited to the present embodiment.

In the present embodiment, the image analysis module 12 can be an application, a hardware chip with the image analysis function, or a combination of both, but the present invention is not limited to this. The processing module 13 can be a Central Processing Unit (CPU), but the processing module 13 is not limited to this, and the processing module 13 can be any of hardware, software, firmware, or a combination of any two. The wireless transmission module 14 is used to transmit the first control signal s1 for the purpose of controlling the illuminating device 90, and the wireless transmission module 14 can be a Bluetooth module, a Wi-Fi transmission module, or a wireless transmission module in any other form.

As shown in FIG. 1A, the illumination controller 30 includes a wireless receiving module 31 and a control module 32, wherein the wireless receiving module 31 receives the first control signal s1, and the control module 32 is electrically connected to the wireless receiving module 31 and the illuminating device 90. It is noted that in the present embodiment, the control module 32 directly transmits the first control signal s1 to the illuminating device 90 to change the illumination mode of the illuminating device 90. In this embodiment, the wireless receiving module 31 can be a Bluetooth module, Wi-Fi module, or a wireless receiving module in any other form, and the control module 32 can be any of hardware, software, and firmware or a combination of any two.

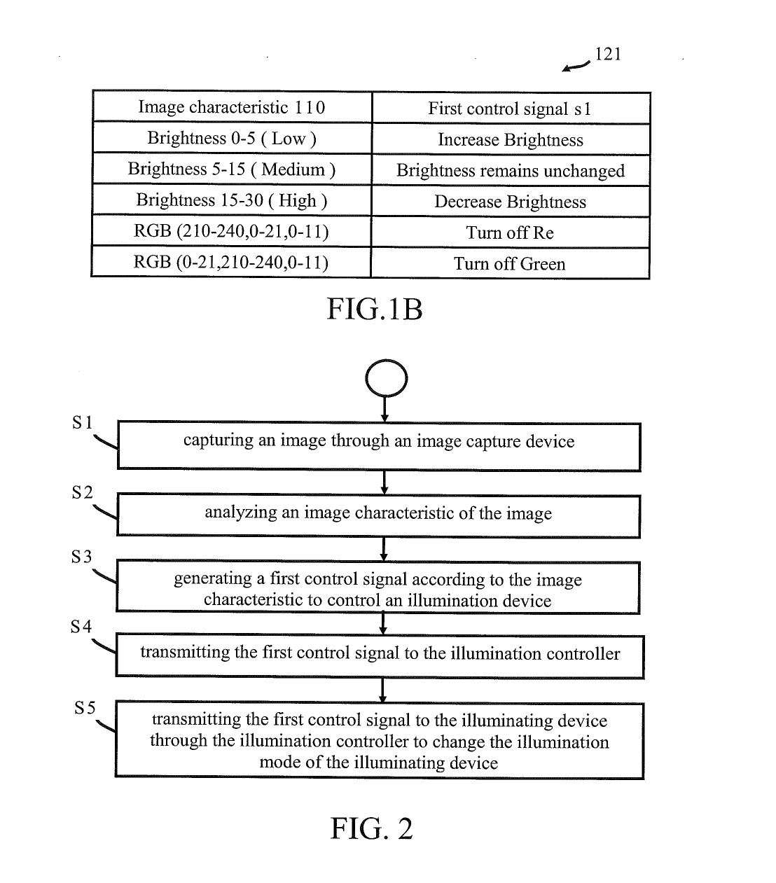

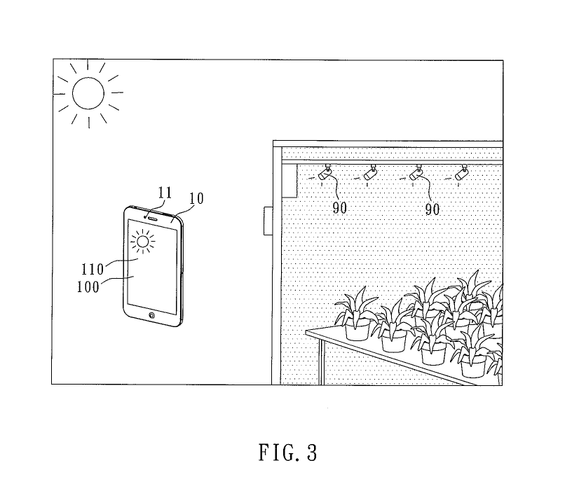

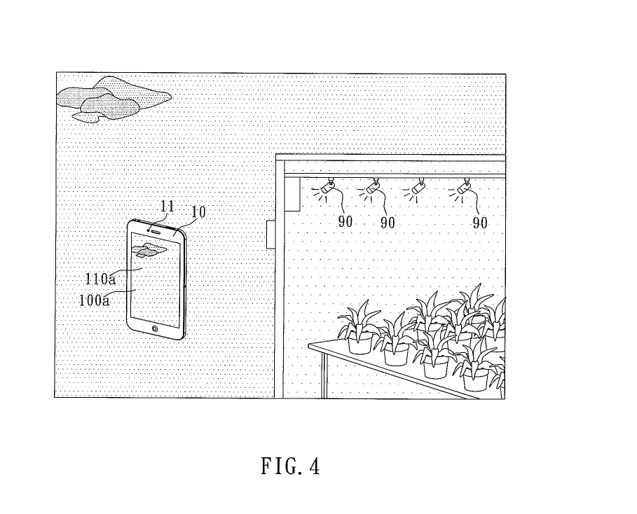

Hereafter, please continue to refer to FIG. 1A and FIG. 1B, together with FIG. 2 to FIG. 4, wherein FIG. 2 is a flowchart showing the steps of an illumination control method according to the first embodiment of the present invention; FIG. 3 a view showing the change of the illumination mode in an illuminating device through the illumination control system according to a characteristic of an image; and FIG. 4 is another view showing the change of the illumination mode in an illuminating device through the illumination control system according to a characteristic of an image. As shown in FIG. 2, in the present embodiment, the illumination control method of the present invention includes Step S1 to Step S5, which will be described in detail hereafter.

Step S1: capturing an image through the image capture device.

When a user wants to use the electronic device 10 to implement the illumination control method in the present invention, as shown in FIG. 3, first, the user employs the image capture module 11 to capture the image 100 corresponding to where the electronic device 10 is located, and then the image 100 is displayed on the screen of the electronic device 10. The image 100 comprises a still image or a moving image.

Step S2: analyzing a characteristic of the image.

After the image capture module 11 captures the image 100, the image analysis module 12 analyzes the overall brightness, grayscale and color difference, or color information of the image 100 to identify the image characteristic 110 of the image 100. For example, as shown in FIG. 3, when the image capture module 11 captures a sunny image 100, after the image is analyzed by the image analysis module 12, it can be found in FIG. 1B that the image characteristic 110 of the image 100 is high brightness. In addition, and for example, as shown in FIG. 4, when the image capture module 11 captures a cloudy image 100a, after the image is analyzed by the image analysis module 12, it can be found in FIG. 1B that the image characteristic 110a of the image 100a is low brightness.

Step S3: generating a first control signal according to the image characteristic of the image.

The image analysis module 12 in the present embodiment includes a first control parameter database 121. For example, as shown in FIG. 1B and FIG. 3, after the image analysis module 12 analyzes and obtains that the image characteristic 110 of the image 100 is high brightness, the processing module 13 identifies the control parameter corresponding to high brightness in the first control parameter database 121 according, to the image characteristic 110 to order to generate the first control signal s1 corresponding to high brightness (the image characteristic 110). In the present embodiment, the first control signal s1 that corresponds to high brightness (the image characteristic 110) is to decrease the brightness of the illuminating device 90.

For example, as shown in FIG. 1B and FIG. 4, after the image analysis module 12 analyzes and obtains that the image characteristic 110a of the image 100a is low brightness, the processing module 13 identifies the control parameter corresponding to low brightness (the image characteristic 110a) in the first control parameter database 121 according to the image characteristic 110a in order to generate the first control signal s1a corresponding to low brightness. In the present embodiment, the first control signal s1a that corresponds to low brightness (the image characteristic 110a) is to increase the brightness of the illuminating device 90.

Step S4: transmitting the first control signal to the illumination controller.

The first control signal s1 or s1a has been generated in the aforementioned Step S3. At this stage, the processing module 13 transmits the first control signal s1 or s1a to the illumination controller 30 through the wireless transmission module 14.

Step S5: transmitting the first control signal to the illuminating device through the illumination controller to change the illumination mode of the illuminating device.

The illumination controller 30 receives the first control signal s1 or s1a through the wireless receiving module 31. Also, the control module 32 in the present embodiment directly transmits the first control signal s1 or s1a to the illuminating device 90 to change the illumination mode of the illuminating device 90. As shown in FIGS. 1A, 1B, and 3, the illuminating device 90 decreases the brightness of the illuminating device 90 according to the first control signal s1. As shown in FIGS. 1A, 1B, and 4, the illuminating device 90 increases the brightness of the illuminating device 90 according to the first control signal s1a.

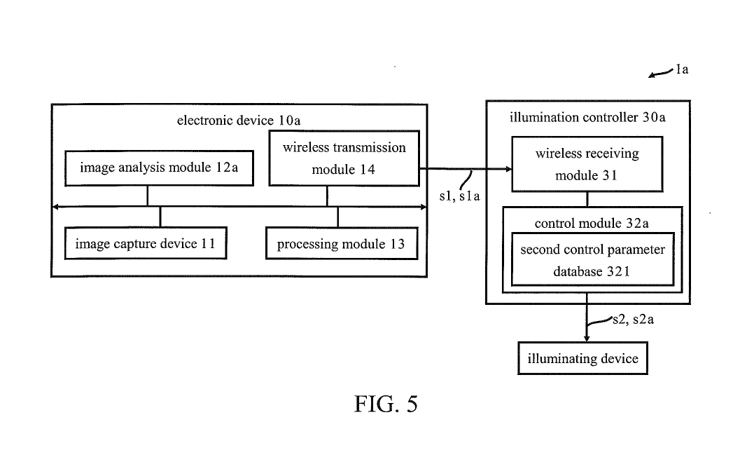

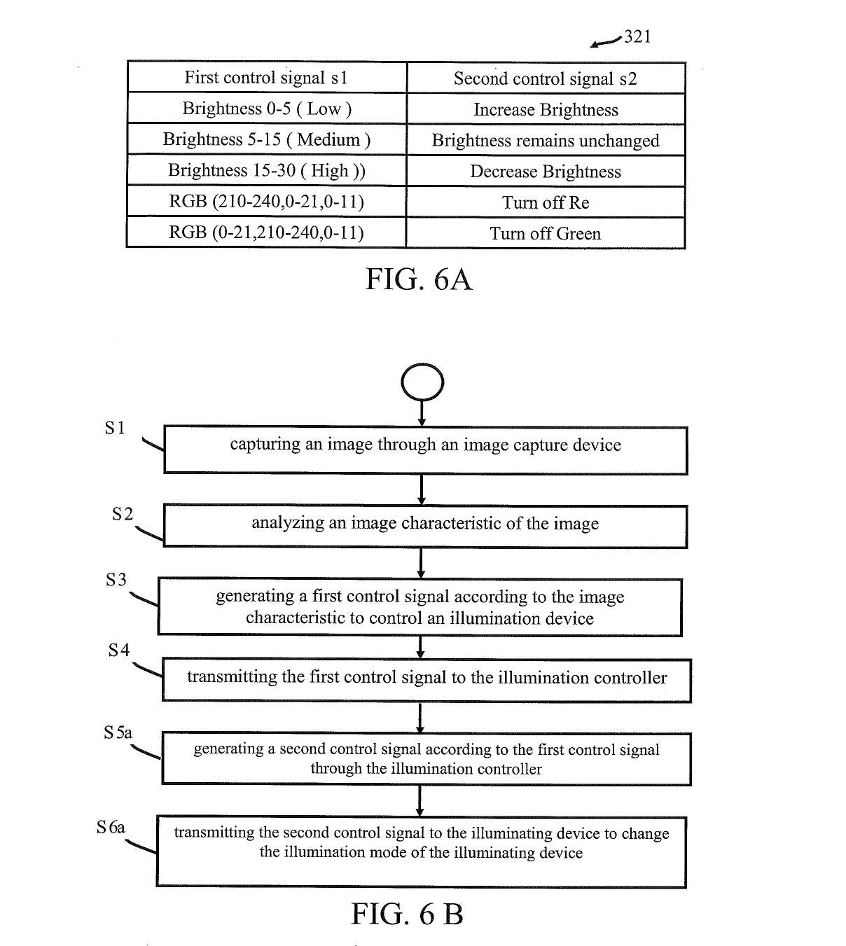

Hereafter, please refer to FIG. 5 and FIG. 6A, wherein FIG. 5 is a hardware architecture diagram of an illumination control system according to the second embodiment of the present invention; FIG. 6A is a schematic diagram of the second control parameter database according to a second embodiment of the present invention.

As shown in FIG. 5, in the second embodiment of the present invention, the image analysis module 12a of the electronic device 10a does not include the first control parameter database 121. Further, the first control signal s1 or s1a generated by the processing module 13 of the electronic device 10a is the image characteristic 110 analyzed by the image analysis module 12a. The first control signal s1 or s1a is transmitted to the illumination controller 30a through the wireless transmission module 14.

Meanwhile, as shown in FIG. 5 and FIG. 6A, the control module 32a of the illumination controller 30a in the present embodiment further includes a second control parameter database 321, such that the control module 32a converts the first control signal s1 or s1a to the second control signal s2 or s2a according to the second control parameter database 321. The second control signal s2 or s2a includes the change of brightness, color temperature, color, On/Off, Flashing mode, or Color-changing mode of the illuminating device 90.

Please refer to all of FIG. 3 to FIG. 6B, wherein FIG. 6B is a flowchart of an illumination control method according to the second embodiment of the present invention. As shown in FIG. 6B, the difference between the second embodiment and the first embodiment is that Step S5a and Step S6a are performed after Step S4 in the illumination control method of the second embodiment. Since Step S1 to Step S4 in the second embodiment are identical to those in the first embodiment, only Step S5a and Step S6a are described hereafter.

Step S5a: generating a second control signal through the illumination controller according to the first control signal.

As shown in FIG. 5, the illumination controller 30a receives the first control signal s1 or s1a through the wireless receiving module 31. It is noted that, as described above, the first control signal s1 or s1a sent by the electronic device 10a is the image characteristic 110 analyzed through the image analysis module 12a. Through the control module 32a, the control parameter corresponding to the first control signal s1 or s1a is found in the second control parameter database 321, and the second control signal s2 or s2a corresponding to the first control signal s1 or s1a is generated such that the step of converting the first control signal s1 or s1a to the second control signal s2 or s2a is completed. It is noted that the step of converting the first control signal s1 or s1a to the second control signal s2 or s2a is substantially identical to the scheme of converting the image characteristic 110 to the first control signal s1 or s1a in the first embodiment, and thus it will not be repeated herein. Please refer to the related description of the first embodiment.

Step S6a: transmitting the second control signal to the illuminating device to change the illumination mode of the illuminating device.

After the second control signal s2 or s2a has been generated in the aforementioned Step S5a, the control module 32a transmits the second control signal s2 or s2a to the illuminating device 90 for changing the illumination mode of the illuminating device 90. As shown in FIGS. 3, 5, and 6A, the illuminating device 90 of the present embodiment decreases the brightness of the illuminating device 90 according to the second control signal s2. As shown in FIGS. 4, 5, and 6A, the illuminating device 90 of the present embodiment increases the brightness of the illuminating device 90 according to the second control signal s2a.

Through the design of analyzing the image characteristic, the illumination mode for the illuminating device with the current ambient conditions can be adjusted. This increases the practicality of the illuminating device and solves the problem in the prior art that the illuminating device cannot change the illumination mode with the ambient conditions such as ambient brightness. It is noted that the described embodiments are not necessarily exclusive and that various changes and modifications may be made to the described embodiments without departing from the scope of the invention as disposed by the appended claims.

What is claimed is:

1. An illumination control system for controlling at least one illuminating device comprising:
an electronic device, comprising:
an image capture device for capturing an image;
an image analysis module for analyzing an image characteristic of the image;
a processing module, which is electrically connected to the image capture device and the image analysis module and generates a first control signal according to the image characteristic; and
a wireless transmission module, electrically connected to the processing module, for transmitting the first control signal to control the at least one illuminating device.

2. The illumination control system as claimed in claim 1, wherein the image characteristic comprises an overall brightness of the image, a grayscale and color difference of the image, or color information of the image.

3. The illumination control system as claimed in claim 2, wherein the image analysis module comprises a first control parameter database, and the processing module converts the image characteristic to the first control signal according to the first control parameter database, wherein the first control signal comprises changing the brightness, color temperature, color, On/Off, Flashing mode, or Color-changing mode of the at least one illuminating device.

4. The illumination control system as claimed in claim 2, further comprising an illumination controller, the illumination controller comprising:
a wireless receiving module for receiving the first control signal; and
a control module, electrically connected to the wireless receiving module and the at least one illuminating device, for generating a second control signal according to the first control signal and for transmitting the second control signal to the at least one illuminating device for changing the illumination mode of the at least one illuminating device.

5. The illumination control system as claimed in claim 4, wherein the control module comprises a second control parameter database, and the control module converts the first control signal to the second control signal according to the second control parameter database, wherein the second control signal comprises the change of brightness, color temperature, color, On/Off, or Flashing mode of the at least one illuminating device.

6. An illumination control method applied to an electronic device for controlling the illumination mode of the at least one illuminating device, wherein the electronic device comprises an image capture device, the illumination control method comprising the following steps:
capturing an image through the image capture device;
analyzing an image characteristic of the image; and
generating a first control signal according to the image characteristic.

7. The illumination control method as claimed in claim 6, further comprising the following steps:
transmitting the first control signal to an illumination controller; and
transmitting the first control signal to the at least one illuminating device through the illumination controller to change the illumination mode of the at least one illuminating device.

8. The illumination control method as claimed in claim 6, further comprising the following steps:
transmitting the first control signal to an illumination controller;
generating a second control signal through the illumination controller according to the first control signal; and
transmitting the second control signal to the at least one illuminating device to change the illumination mode of the at least one illuminating device.

9. The illumination control method as claimed in claim 7, wherein the image characteristic comprises the brightness, grayscale and color difference, or color information of the image.

10. The illumination control method as claimed in claim 8, wherein the second control signal comprises the change of brightness, color temperature, color, On/Off, Flashing mode, or Color-changing mode of the at least one illuminating device.
